(19) United States
(12) Patent Application Publication
(10) Pub. No.: US 2026/0244238 A1
(43) Pub. Date: Aug. 20, 2026

(54) OPTICAL COMPUTING SYSTEM, COMPUTING COMPENSATION METHOD, AND PHOTONIC INTEGRATED CIRCUIT CHIP

(71) Applicant: SHANGHAI XIZHI TECHNOLOGY CO., LTD., Shanghai (CN)

(72) Inventors: Yichen Shen, Shanghai (CN); Huaiyu Meng, Shanghai (CN); Shiyue Hua, Shanghai (CN); Bo Peng, Shanghai (CN); Jinghui Zou, Shanghai (CN)

(21) Appl. No.: 19/646,487

(22) Filed: Apr. 13, 2026

Related U.S. Application Data
(63) Continuation of application No. PCT/CN2024/138677, filed on Dec. 12, 2024.

(30) Foreign Application Priority Data
Oct. 13, 2023 (CN) 202311332234.1

(51) Int. Cl. G06E 3/00

(52) U.S. Cl. CPC G06E 3/001

(57) ABSTRACT

The present disclosure provides an optical computing system, a computation compensation method, and a photonic integrated circuit chip. The optical computing system includes a beam splitter configured to divide an input optical signal into first and second branches according to a predetermined ratio; a computing module configured to receive the second branch and perform computation on information represented by an optical signal; a monitoring module configured to monitor the first branch in real time; and a post-processing module configured to compensate a computing result output by the computing module based on a monitoring result. The monitoring module enables real-time tracking of incident optical power variations and corresponding compensation of computational accuracy.

### CROSS-REFERENCE TO RELATED APPLICATION(S)

This application claims priority to Chinese Patent Application No. 202311332234.1 filed on Oct. 13, 2023, and entitled “Optical Computing System, Computing Compensation Method, and Photonic Integrated Circuit Chip”, the entire disclosure of which is incorporated herein by reference.

### FIELD OF THE INVENTION

The present disclosure relates to the field of optical computing, and specifically relates to an optical computing system, a computing compensation method, and a photonic integrated circuit chip.

### BACKGROUND OF THE INVENTION

Optical computing uses light as an information carrier. Information is typically encoded in characteristics of light, such as phase and intensity, and manipulation of these characteristics corresponds to computational processing. High-precision optical computing generally requires stable optical input. However, in practice, optical signals generated by light sources often fail to meet the stability requirements. In particular, in silicon photonic integrated systems with additional light sources, achieving stable optical input remains a significant challenge, thereby limiting computational accuracy.

### SUMMARY OF THE INVENTION

In view of the deficiencies of existing optical computing systems, the present disclosure provides an optical computing system, a computing compensation method, and a photonic integrated circuit chip.

In one aspect, embodiments of the present disclosure provide an optical computing system, comprising:
a beam splitter configured to split a light wave input into the optical computing system into a first branch and a second branch according to a predetermined ratio;
a computing module configured to receive the light wave of the second branch, modulate an electrical signal onto the light wave of the second branch to generate an optical signal, and perform computation on information (or data) represented by the optical signal;
a monitoring module configured to receive the light wave of the first branch and perform real-time monitoring thereof; and
a post-processing module configured to perform a compensation operation on computing results output by the computing module based on monitoring results generated by the monitoring module.

In some embodiments, the monitoring results comprise optical power values, which are indicative of light intensity or source brightness.

In some embodiments, the compensation operation comprises:
acquiring a current computing result output by the computing module and a current optical power value obtained by the monitoring module;
dividing the current computing result by the current optical power value to obtain a first intermediate value; and
multiplying the first intermediate value by a monitoring result corresponding to an anchor power to compensate the current computing result.

In some embodiments, the post-processing module comprises:
a divider configured to divide the current computing result by the current optical power value to obtain the first intermediate value; and
a multiplier configured to multiply the first intermediate value by the monitoring result corresponding to the anchor power.

In some embodiments, the monitoring module comprises:
a photodetector optically coupled to the first branch of the beam splitter and configured to convert the light wave of the first branch into an analog electrical signal; and
an analog-to-digital converter (ADC) configured to convert the analog electrical signal into a digital electrical signal representing the monitoring result.

In some embodiments, the monitoring module further comprises a transimpedance amplifier disposed between the photodetector and the analog-to-digital converter.

In some embodiments, the computing module comprises an optical modulator unit, an optical matrix multiplication unit, a photodetector unit, and an analog-to-digital conversion unit.

In another aspect, embodiments of the present disclosure provide a method for compensating optical computing results, comprising:
splitting a light wave input into an optical computing system into a first branch and a second branch according to a predetermined ratio using a beam splitter;
transmitting the light wave of the second branch to a computing module of the optical computing system, wherein the computing module is configured to modulate an electrical signal onto the light wave of the second branch to generate an optical signal and perform computation on information represented by the optical signal;
monitoring the light wave of the first branch in real time to obtain monitoring results; and
performing a compensation operation on computing results output by the computing module based on the obtained monitoring results.

In some embodiments, the monitoring results comprise optical power values, which are indicative of light intensity or source brightness.

In some embodiments, the compensation comprises:
acquiring a current computing result output by the computing module and a current optical power value obtained from monitoring;
dividing the current computing result by the current optical power value to obtain a first intermediate value; and
multiplying the first intermediate value by a monitoring result corresponding to an anchor power to compensate the current computing result.

In some embodiments, obtaining the current optical power value comprises:
obtaining a first optical power value by real-time monitoring of the light wave of the first branch; and
using the first optical power value as the current optical power value.

In other embodiments, obtaining the current optical power value comprises:
acquiring a system offset;
obtaining a first optical power value by real-time monitoring of the light wave of the first branch; and
determining the current optical power value by subtracting the system offset from the first optical power value.

In some embodiments, the method further comprises acquiring a system offset, and, prior to dividing the current computing result by the current optical power value, subtracting the offset from the current optical power value to obtain a second intermediate value, and dividing the current computing result by the second intermediate value to obtain the first intermediate value.

In a further aspect, embodiments of the present disclosure provide a photonic integrated circuit chip, comprising:
a beam splitter having an input port for receiving an input light wave, a first output port and a second output port for outputting light waves, and configured to split the input light wave into a first branch output from the first output port and a second branch output from the second output port according to a predetermined ratio;
an optical processing module optically coupled to the second output port and configured to receive the light wave of the second branch, modulate an electrical signal onto the light wave of the second branch to generate an optical signal, and perform optical processing on the optical signal, wherein the optical processing comprises computation on information represented by the optical signal; and
a photodetector optically coupled to the first output port and configured to convert the light wave of the first branch into an analog electrical signal.

In some embodiments, the optical processing module comprises an optical modulator unit, an optical matrix multiplication unit, and a photodetector unit.

The present disclosure provides the following advantageous effects. By incorporating the monitoring module, variations in input optical power can be monitored in real time, and corresponding compensation can be performed on the computing results, thereby improving computational accuracy.

Various aspects, features, and advantages of the present disclosure will be described in detail below with reference to the accompanying drawings, from which the foregoing and other aspects and advantages will become more apparent.

### BRIEF DESCRIPTION OF THE DRAWINGS

FIG. 1 is a block diagram of an optical computing system according to an embodiment of the present disclosure.

FIG. 2 is a block diagram of a monitoring module according to an embodiment of the present disclosure.

FIG. 3 is a block diagram of a post-processing module according to an embodiment of the present disclosure.

FIG. 4 is a block diagram of an optical computing system including a photonic integrated circuit chip according to another embodiment of the present disclosure.

### DETAILED DESCRIPTION OF THE INVENTION

Exemplary embodiments of the present disclosure will be described in greater detail below with reference to the accompanying drawings. Certain terms used herein are for convenience of reference only and are not intended to limit the scope of the present disclosure. Unless the context clearly indicates otherwise, ordinal terms such as “first” and “second” do not denote any order or sequence.

It should be understood that when an element or feature is described as being “connected to” or “coupled to” another element or feature, it may be directly connected or coupled to the other element or feature, or one or more intermediate elements or features may be present. Similarly, when an element or feature is described as being “between” two elements, it may be the only element between the two elements, or one or more additional elements may also be present.

The terminology used herein is for the purpose of describing specific embodiments only and is not intended to limit the present disclosure. Such terms include the words specifically mentioned herein, their derivatives, and words with similar meanings. As used herein, the singular forms “a,” “an,” and “the” include plural forms as well, unless the context clearly indicates otherwise. The terms “comprise,” “include,” and “have” specify the presence of stated features, integers, steps, operations, elements, and/or components, but do not preclude the presence or addition of one or more other features, integers, steps, operations, elements, components, and/or combinations thereof. The term “and/or” includes any and all combinations of one or more of the associated listed items. Expressions such as “at least one of” modify the entire list of elements rather than individual elements in the list.

As used herein, terms such as “substantially” and “approximately” are intended to account for inherent variations in measured or calculated values as recognized by those skilled in the art. The terms “use,” “using,” and “used” may be considered synonymous with “utilize,” “utilizing,” and “utilized,” respectively.

In silicon photonic systems, achieving stable optical input to a chip requires not only stable emission from the light source, but also sufficient stability during coupling of the emitted light into the chip. In practice, existing solutions fail to meet the long-term stability requirements of high-precision computation. Such limitations may lead to instability in optical computing systems and degradation in computational accuracy, thereby hindering practical deployment of optical computing technologies.

The present disclosure addresses these issues by incorporating a monitoring module configured to monitor variations in input optical power in real time and to enable corresponding compensation of computational accuracy.

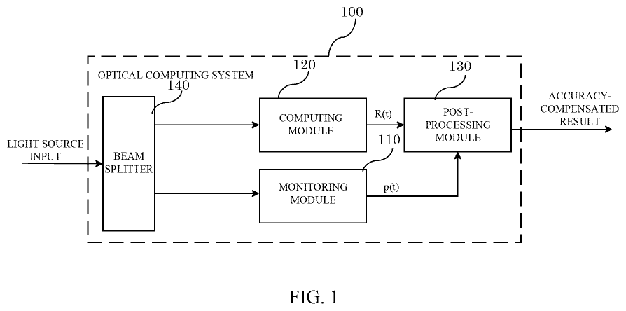

As shown in FIG. 1, in an exemplary embodiment, an optical computing system 100 includes, but is not limited to, a beam splitter 140, a monitoring module 110, a computing module 120, and a post-processing module 130.

The beam splitter 140 is configured to split a light wave input into the optical computing system into a first branch and a second branch according to a predetermined ratio, wherein the light wave of the first branch is transmitted to the monitoring module 110 and the light wave of the second branch is transmitted to the computing module 120. In some embodiments, the beam splitter 140 includes an input port for receiving the input light wave, and a first output port and a second output port for outputting light waves, wherein the light wave of the first branch is output from the first output port, and the light wave of the second branch is output from the second output port.

The computing module 120 is configured to receive the light wave of the second branch, modulate an electrical signal onto the light wave of the second branch to generate an optical signal, and perform computation on information represented by the optical signal. In some embodiments, the computing module 120 includes one or more of: an optical modulator unit, an optical matrix multiplication unit, a photodetector unit, a transimpedance amplifier unit, and an analog-to-digital conversion unit. The optical modulator unit includes one or more modulators configured to modulate the optical signal using the electrical signal. The optical matrix multiplication unit performs matrix multiplication on the optical signal. The photodetector unit includes one or more photodetectors and converts optical outputs from the optical matrix multiplication unit into photocurrent. The transimpedance amplifier unit converts the photocurrent into a voltage signal and amplifies it. The analog-to-digital conversion unit converts the voltage signal into a digital signal representing a computing result.

The monitoring module 110 is configured to receive the light wave of the first branch and perform real-time monitoring thereof. In some embodiments, the monitoring module 110 measures optical intensity or brightness.

The post-processing module 130 is configured to perform a compensation operation on the computing results output by the computing module 120 based on monitoring results obtained by the monitoring module 110.

In the exemplary embodiment, the monitoring results obtained by the monitoring module 110 through the monitoring includes an optical power value. The optical power value may be used to measure the intensity or brightness of the light wave. The compensation operation performed by the post-processing module 130 includes: when the current input optical power is P(t), acquiring the current computing result R(t) output by the computing module and the current optical power value p(t) provided by the monitoring module; dividing the current computing result by the current power value to obtain a first intermediate value k, where k=R(t)/p(t); and multiplying the first intermediate value by the monitoring result p_ref corresponding to the anchor power P_ref to satisfy P(t)/p(t)=P_ref/p_ref and compensate the current computing result of the computing module. The accuracy-compensated result R_ref=k×p_ref, where p_ref is the monitoring result corresponding to the anchor power P_ref. Theoretically, the optical computing result R is proportional to the input light intensity (i.e., optical power P). By monitoring the value of P in real time, the computing result per unit light intensity R/P can be obtained, based on which the computing result R_ref at the anchor power P_ref can be deduced.

Specifically, the computing result per unit light intensity can be calculated by the following formula (1):

$$R / P = R ( t ) / P ( t ) = R\_ref / P\_ref ; \qquad ( 1 )$$

Moreover, the splitting ratio of the beam splitter 140 is fixed, that is, the ratio between the optical power P input into the computing system and the optical power p input into the monitoring module is fixed at all times:

$$P ( t ) / p ( t ) = P\_ref / p\_ref ; \qquad ( 2 )$$

It can be derived from formula (1) and formula (2) that R_ref=R(t)/p(t)×p_ref.

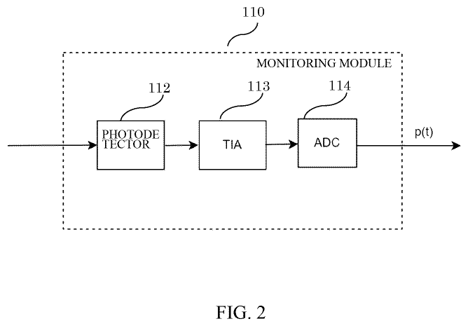

As shown in FIG. 2, in the exemplary embodiment, the monitoring module 110 includes: a photodetector 112 optically coupled to the first branch of the beam splitter and configured to convert the light wave of the first branch into an analog electrical signal; and an analog-to-digital converter (ADC) 114 configured to convert the analog electrical signal into a digital monitoring result.

In some embodiments, the beam splitter 140 may have a splitting ratio of, for example, 95/5, which splits 5% of the light wave from the input light to enter the monitoring module 110 via the first branch of the beam splitter for power monitoring, and the remaining 95% of the light wave continues to enter the computing module 120 for processing, thereby realizing real-time monitoring of input light without affecting the processing accuracy of the computing module 120. It should be understood that any proportion of light waves can be split for real-time monitoring as long as the accurate information processing of the computing module 120 is not affected, that is, beam splitters with any splitting ratio can be adopted under the premise of ensuring accurate information processing of the computing module 120.

In some embodiments, the monitoring module 110 further includes a transimpedance amplifier (TIA) 113 disposed between the photodetector 112 and the ADC 114. The transimpedance amplifier 113 is configured to convert photocurrent signal detected by the photodetector 112 into a voltage signal and amplify the signal.

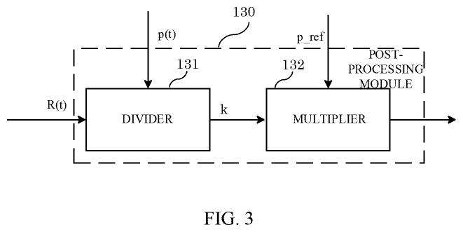

As shown in FIG. 3, in the exemplary embodiment, the post-processing module 130 includes a divider 131 and a multiplier 132. The divider 131 has a first input end connected to the monitoring module 110 and a second input end connected to the computing module 120. The divider 131 is configured to divide the current computing result R(t) provided by the computing module 120 by the current power value p(t) provided by the monitoring module 110 to obtain the first intermediate value k. The multiplier 132 has a first input end connected to the divider 131 to receive the first intermediate value k, and a second input end for receiving the predetermined monitoring result p_ref corresponding to the anchor power P_ref. The multiplier 132 is configured to multiply the first intermediate value k by the monitoring result p_ref corresponding to the anchor power P_ref to obtain the computing result R_ref corresponding to the anchor power.

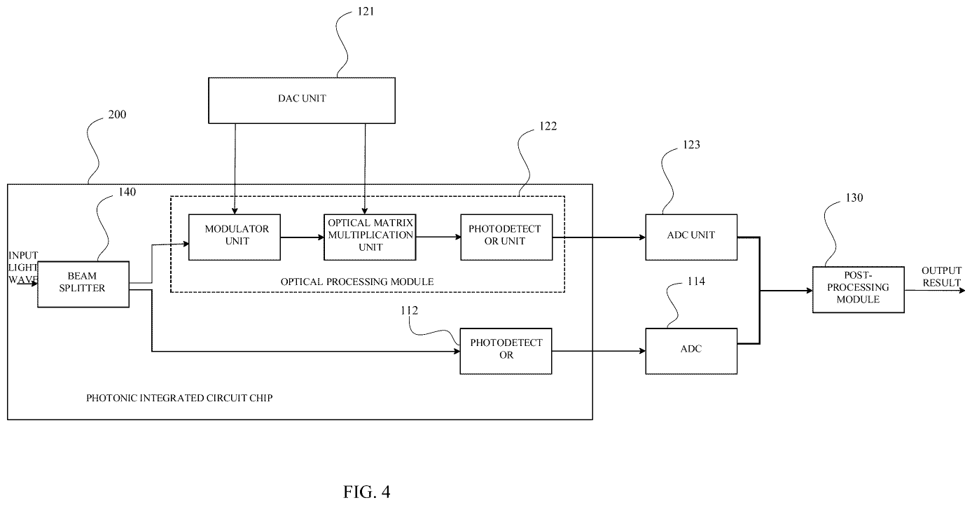

It can be seen from the above description that the monitoring module 110 involves optical processing devices (such as the photodetector 112) and electrical processing devices (such as the TIA 113 and ADC 114). The optical processing devices can be integrated on the photonic integrated circuit chip together with the optical processing devices in the computing module 120. The post-processing module 130 mainly performs data post-processing in the digital domain. In some embodiments, the computing module 120 converts the optical signal representing the current computing result into an analog electrical signal through photonic-electronic conversion, and further converts the analog electrical signal into a digital electrical signal representing the current computing result through analog-to-digital conversion. The post-processing module 130 performs compensation operation on the current computing result represented by the digital electrical signal. It should be understood that the electrical processing related devices of the post-processing module 130 and the monitoring module 110 can be implemented by one or more electronic integrated circuit chips or electronic devices. The one or more electronic integrated circuit chips or electronic devices are packaged together with the optical chip to form the device implementing the optical computing system 100. FIG. 4 shows the structure of an optical computing system including a photonic integrated circuit chip 200 according to another exemplary embodiment.

In the exemplary embodiment, as shown in FIG. 4, a photonic integrated circuit chip 200 provided by the present disclosure includes, but is not limited to, a beam splitter 140, an optical processing module 122, and a photodetector 112.

The input light wave is split into two branches for output by the beam splitter 140 according to a predetermined ratio, wherein the light wave of the first branch is transmitted to the photodetector 112, and the light wave of the second branch is transmitted to the optical processing module 122. The beam splitter 140 has an input port, a first output port and a second output port, wherein the light wave of the first branch is output from the first output port, and the light wave of the second branch is output from the second output port.

The optical processing module 122 is connected to the second output port of the beam splitter 140 to receive the light wave of the second branch. As shown in FIG. 4, the optical processing module 122 may include a modulator unit, an optical matrix multiplication unit, and a photodetector unit. The modulator unit includes multiple optical modulators for modulating the light wave of the second branch using an electrical signal from the DAC unit 121 to form the optical signal. The optical matrix multiplication unit is used to perform matrix multiplication operations on an optical signal. The photodetector unit includes multiple photodetectors for receiving the optical output of the optical matrix multiplication unit and generating corresponding photocurrent, which is converted into a digital signal representing the current computing result by the ADC unit 123. In an optional embodiment, the optical processing module 122 further includes an additional beam splitter (such as a 1×N beam splitter) for splitting the light wave of the second branch into multiple light waves with equal optical power and transmit them to the modulator unit.

The photodetector 112 is connected to the first output port of the beam splitter 140 to receive the light wave of the first branch. The photodetector 112 is configured to convert the light wave of the light wave of the first branch into an analog electrical signal, which is converted into a digital signal representing the monitored current optical power value by the ADC 114. The digital signal representing the current computing result and the digital signal representing the monitored current optical power value are input into the post-processing module 130 for computing result compensation processing, which is consistent with the processing described above in conjunction with FIG. 3 and will not be repeated herein.

In some embodiments, the input light wave comes from a light source outside the chip and is coupled into the photonic integrated circuit chip 200 through an optical input coupler (not shown in FIG. 4). The optical input coupler includes a grating coupler. The light source generating the input light wave includes a semiconductor laser, and the laser generated thereby is transmitted to the grating coupler through an optical fiber or an optical fiber array. The grating coupler couples the laser into the photonic integrated circuit chip. In an optional embodiment, the semiconductor laser can be integrated inside the photonic integrated circuit chip 200. In this case, the photonic integrated circuit chip 200 can omit the grating coupler, and the input light is transmitted directly inside the chip.

Although not shown, it should be understood that the photonic integrated circuit chip 200 further includes multiple optical waveguides for realizing optical connection and optical communication between various optical devices in the chip. The photonic integrated circuit chip 200 also includes multiple conductive paths for realizing electrical connection and information transmission between electronic components inside and outside the chip.

In another exemplary embodiment, an optical computing system may include a photonic integrated circuit chip 200, a post-processing module 130, a DAC unit 121, an ADC unit 123, and an ADC 114. The photodetector 112 and the ADC 114 in the photonic integrated circuit chip 200 can serve as exemplary components of the aforesaid monitoring module 110, and the optical processing module 122, the DAC unit 121 and the ADC unit 123 in the photonic integrated circuit chip 200 can serve as exemplary components of the aforesaid computing module 120. In some embodiments, one or any combination of the post-processing module 130, the DAC unit 121, the ADC unit 123 and the ADC 114 can be configured or integrated on an electronic integrated circuit chip.

As described above, the present disclosure also provides a method for compensating optical computing results. In an exemplary embodiment, the method comprising:
splitting a light wave input into an optical computing system into a first branch and a second branch according to a predetermined ratio using a beam splitter;
transmitting the light wave of the second branch to a computing module of the optical computing system, wherein the computing module is configured to modulate an electrical signal onto the light wave of the second branch to generate an optical signal and perform computation on information represented by the optical signal;
monitoring the light wave of the first branch in real time to obtain monitoring results; and
performing a compensation operation on computing results output by the computing module based on the obtained monitoring results.

In some embodiments, the monitoring results comprise optical power values, which are indicative of light intensity or source brightness.

In some embodiments, the compensation operation comprises:
acquiring a current computing result R(t) output by the computing module and a current optical power value p(t) obtained from monitoring;
dividing the current computing result by the current optical power value to obtain a first intermediate value k, where k=R(t)/p(t);
multiplying the first intermediate value k by the monitoring result p_ref corresponding to an anchor power P_ref to compensate the current computing result, such that the accuracy-compensated result R_ref=k×p_ref.

In some embodiments, obtaining the current optical power value comprises:
obtaining a first optical power value by real-time monitoring of the light wave of the first branch; and
using the first optical power value as the current optical power value.

In other embodiments, obtaining the current optical power value comprises:
acquiring a system offset;
obtaining a first optical power value by real-time monitoring of the light wave of the first branch; and
determining the current optical power value by subtracting the offset from the first optical power value.

The offset is caused by imperfections of system devices, mainly including dark current of photodetectors, deviation of ADCs, etc. The offset can be extracted by turning off the external light source and measuring the output of the ADC 114.

In some embodiments, the method further comprises acquiring the system offset B, which is caused by imperfections of system devices, mainly including dark current of photodetectors, deviation of ADCs, etc. The offset B can be extracted by turning off the external light source and measuring the output of the ADC 114. Accordingly, the method further comprises prior to dividing the current computing result by the power value, subtracting the offset B from the current optical power value p(t) provided by the monitoring module to obtain a second intermediate value k′, that is, k′=p(t)−B, and dividing the current computing result by the second intermediate value to obtain the first intermediate value k, that is, k=R(t)/(p(t)−B).

Those skilled in the art will appreciate that the foregoing embodiments are illustrative only and are not intended to limit the scope of the present disclosure. Any equivalent changes made according to the embodiments of the present disclosure shall still fall within the scope covered by the claims of this application.

1. An optical computing system, comprising:
a beam splitter configured to split a light wave input into the optical computing system into a first branch and a second branch according to a predetermined ratio;
a computing module configured to receive the light wave of the second branch, modulate an electrical signal onto the light wave of the second branch to generate an optical signal, and perform computation on information represented by the optical signal;
a monitoring module configured to receive the light wave of the first branch and perform real-time monitoring thereof; and
a post-processing module configured to perform a compensation operation on computing results output by the computing module based on monitoring results generated by the monitoring module.

2. The optical computing system according to claim 1, wherein the monitoring results comprise optical power values.

3. The optical computing system according to claim 2, wherein the compensation operation comprises:
acquiring a current computing result output by the computing module and a current optical power value obtained by the monitoring module;
dividing the current computing result by the current optical power value to obtain a first intermediate value; and
multiplying the first intermediate value by a monitoring result corresponding to an anchor power to compensate the current computing result.

4. The optical computing system according to claim 3, wherein the post-processing module comprises:
a divider configured to divide the current computing result by the current optical power value to obtain the first intermediate value; and
a multiplier configured to multiply the first intermediate value by the monitoring result corresponding to the anchor power.

5. The optical computing system according to claim 1, wherein the monitoring module comprises:
a photodetector optically coupled to the first branch of the beam splitter and configured to convert the light wave of the first branch into an analog electrical signal; and
an analog-to-digital converter configured to convert the analog electrical signal into a digital electrical signal representing the monitoring result.

6. The optical computing system according to claim 5, wherein the monitoring module further comprises a transimpedance amplifier disposed between the photodetector and the analog-to-digital converter.

7. The optical computing system according to claim 1, wherein the computing module comprises an optical modulator unit, an optical matrix multiplication unit, a photodetector unit, and an analog-to-digital conversion unit.

8. A method for compensating optical computing results, comprising:
splitting a light wave input into an optical computing system into a first branch and a second branch according to a predetermined ratio using a beam splitter;
transmitting the light wave of the second branch to a computing module of the optical computing system, wherein the computing module is configured to modulate an electrical signal onto the light wave of the second branch to generate an optical signal and perform computation on information represented by the optical signal;
monitoring the light wave of the first branch in real time to obtain monitoring results; and
performing a compensation operation on computing results output by the computing module based on the obtained monitoring results.

9. The method according to claim 8, wherein the monitoring results comprise optical power values.

10. The method according to claim 9, wherein the compensation comprises:
acquiring a current computing result output by the computing module and a current optical power value obtained from monitoring;
dividing the current computing result by the current optical power value to obtain a first intermediate value; and
multiplying the first intermediate value by a monitoring result corresponding to an anchor power to compensate the current computing result.

11. The method according to claim 10, wherein obtaining the current optical power value comprises:
obtaining a first optical power value by real-time monitoring of the light wave of the first branch; and
using the first optical power value as the current optical power value.

12. The method according to claim 11, wherein obtaining the current optical power value comprises:
acquiring a system offset;
obtaining a first optical power value by real-time monitoring of the light wave of the first branch; and
determining the current optical power value by subtracting the system offset from the first optical power value.

13. A photonic integrated circuit chip, comprising:
a beam splitter having an input port for receiving an input light wave, a first output port and a second output port for outputting light waves, and configured to split the input light wave into a first branch output from the first output port and a second branch output from the second output port according to a predetermined ratio;
an optical processing module optically coupled to the second output port and configured to receive the light wave of the second branch, modulate an electrical signal onto the light wave of the second branch to generate an optical signal, and perform optical processing on the optical signal, wherein the optical processing comprises computation on information represented by the optical signal; and
a photodetector optically coupled to the first output port and configured to convert the light wave of the first branch into an analog electrical signal.

14. The photonic integrated circuit chip according to claim 13, wherein the optical processing module comprises an optical modulator unit, an optical matrix multiplication unit, and a photodetector unit.
